(19) United States
(12) Patent Application Publication
(10) Pub. No.: US 2014/0315423 A1
(43) Pub. Date: Oct. 23, 2014

(54) MOUNTED POWER CORD

(71) Applicants: Theodore J. Cole, Wyoming, MI (US); Douglas D. Sharp, Spring Lake, MI (US)

(72) Inventors: Theodore J. Cole, Wyoming, MI (US); Douglas D. Sharp, Spring Lake, MI (US)

(21) Appl. No.: 13/737,935

(22) Filed: Apr. 22, 2013

(51) Int. Cl. H01R 13/72

(52) U.S. Cl. CPC H01R 13/72
USPC 439/501

(57) ABSTRACT

A ceiling mounted extension cord that can be disposed in and HVAC diffuser and can be displaced from a ceiling mounted position to a deployed position for use. The extension cord can also be retracted upwardly adjacent the ceiling. The displacement of the cord may be by remote control.

### FIELD OF THE INVENTION

This invention relates to an apparatus that carries electrical current from a ceiling downwardly or from a wall to an electrical apparatus.

### BACKGROUND OF THE INVENTION

Electrical outlets and extension cords provide power sources for home and office use. The extension cords of the prior art are often connected to wall outlets. Floor outlets are also available, usually in industrial or office settings. Some desks or workstations allow for cords to be plugged into them, and then the desk may have an internal cord to carry the current or electricity to an outlet on the desk.

In many jurisdictions, it is a code violation to run extension cords through walls or ceilings.

There are patents on HVAC diffusers, i.e. U.S. Pat. Nos. 3,765,316, 4,679,495, and 7,641,125.

The patentability search discovered relevant U.S. Pat. Nos. 7,309,834, 5,723,815, and 7,897,869. These are all types of wall mounted retractable extension cords.

The retractable electrical cord box apparatus of U.S. Pat. No. 7,897,869 is an apparatus which encloses a retractable extension cord that is mounted on a wall closely adjacent to a standard wall outlet. The purpose for the invention is to provide a handy and neatly retractable extension cord disposed in such apparatus.

U.S. Pat. Nos. 5,723,815 and 7,309,834 are also types of retractable extension cord apparatus that are mounted on walls. The main difference is that they are not connected to diffusers therefore may not be mounted on ceilings.

It turns out this could be a valuable addition, especially in its motorized, remote control edition, for high, open ceilings like those found in grocery stores and other large facilities, that don't typically have drop ceilings, but instead have much higher, open ceilings. Apparently, hours are spent every day in many grocery stores using lift carts just to plug in and remove various extension cords from ceiling-based locations, hours that could be recouped by this solution.

The present invention is different from U.S. Pat. Nos. 5,723,815 and 7,309,834 extension cord apparatus because the present invention has a dual function. The present invention may be connected to a modified HVAC diffuser in which case is connected to a ceiling or it can be used without being connected to a diffuser in which case it can be mounted to a wall panel for the purpose of safety and also as a convenient way to store extension cord when not in use.

There exists a need for a cord or outlet that is accessible from the ceiling or wall.

There also exists a need for a retractable ceiling cord, and retractable wall cord.

There exists a need for a motorized retractable cord that will provide a power source when needed. There also exists a need to have a cord, that, when not in use, the user can retract the cord to the ceiling keeping the area aesthetically pleasing. The

cord will be mounted within an HVAC diffuser and installed in a drop ceiling to avoid violating electric

codes. Both the modified HVAC diffuser and the device will be packaged together as a complete

assembly. ready to install. It will be remotely controlled and capable of saving a desired length.

Multiple embodiments of the system are disclosed herein. It will be understood that other objects and purposes of the invention, and variations thereof, will be apparent upon reading the following specification and inspecting the accompanying drawings.

### SUMMARY OF THE INVENTION

One aspect of the present invention is a mounted power cord (10), comprising: a retracting means (40) disposed on a ceiling; a power cord (30) retractably connected to said retracting means (40); and a power source (50) operably connected to said power cord (30).

These and other features, aspects and advantages of the present invention will become better understood with reference to the following drawings, description and claims.

### BRIEF DESCRIPTION OF THE DRAWINGS

FIG. 1 is a pictorial view of one embodiment of the present invention;

FIG. 2 is another pictorial view of an embodiment of the present invention;

FIG. 3 is another pictorial view of an embodiment of the present invention;

FIG. 4 is another pictorial view of an embodiment of the present invention;

FIG. 5 is another pictorial view of another embodiment of the present invention;

FIG. 6 is another pictorial view of an embodiment of the present invention;

FIG. 7 is another pictorial view of another embodiment of the present invention;

FIG. 8 is pictorial view of a clutch of an embodiment of the present invention; and

FIG. 9 is a pictorial view of a weight of the present invention.

Certain terminology will be used in the following description for convenience and reference only, and will not be limiting. For example, the words “upwardly,” “downwardly,” “rightwardly,” and “Ieftwardly” will refer to directions in the drawings to which reference is made. The words “inwardly” and “outwardly” will refer to directions toward and away from, respectively, the geometric center of the system and designated parts. Said terminology will include the words specifically mentioned, derivatives, and similar words.

### DETAILED DESCRIPTION

### Reference Numerals List

10 mounted power cord
20 cord housing or ceiling unit
30 power cord or extension cord
40 displacement means
50 power source
60 cord plug portion
70 diffuser
80 retracted position
90 non-retracted position
100 power outlet
110 circuit breaker reset button
120 top side
130 remote control
140 spool
150 motor
160 transceiver
170 input cable
180 metal flex conduit
190 access panel
200 smart phone app
210 rectangular tubes
220 motor circuitry
230 clutch discs
250 discs
260 thrust bearing
270 top clutch plate
280 clutch material
290 bottom clutch plate
300 roller bearing
310 support system bracket
320 spool hub
330 weight
340 DC-DC switch voltage regulator
350 pull ring

In one embodiment, there are two parts to the present invention: (1) the ceiling unit 20, also referred to herein as the cord housing 20 and (2) the remote control 130. The ceiling unit 20 includes a displacement means 40 to wind up the extension cord 30, also referred to herein as a power cord 30, a motor 150 that can convert AC power to DC, and may have a transceiver 160 to receives wireless data from the remote control 130. In one embodiment, The vertical gear motor that was selected is due to its relatively short height and high torque values.

In one embodiment a suitable motor 150 may be one from Anaheim Automation and was model number BDPG-36-57-24V-4200-R27. The motor may be further geared down at a 3:1 ratio to the clutch/pulley component.

In one embodiment the displacement means 40 may be a motorized spool 140. The extension cord 30 may be wound on the motorized spool 140, and the motorized spool 140 may be operably connected to the motor 150. The motorized spool 140 and the motor 150 may be disposed within the ceiling unit 20.

The ceiling unit 20 may be disposed within the HVAC diffuser. The remote control 130 can contain the necessary hardware or software to communicate with the motor 150 and provide a very simple and intuitive user interface.

In one embodiment, the present invention 10 can have the following components and features:

1. A power source 50 that is an input cable 170 and can be about 6 feet long, shielded by metal flex conduit 180. The input cable 170 or the metal flex conduit 180 may be connected to motor circuitry 220 inside the ceiling unit 20 with wire nuts so that any of the components can be replaced or repaired during or after installation.

2. The ceiling unit 20 can contain an access panel 190 that can house the motor circuitry 220, at least a portion of the metal flex conduit 180, and possibly the motor 150, and any unshielded wire connections.

3. The extension cord 30 can extend up to 25 ft.

4. The extension cord 30 can be rated for at least 15 A and 120 VAC.

5. The ceiling unit 20 can be flush to the ceiling and can blend into an office environment.

6. Service life of the ceiling unit 20 or motorized spool 140 can be 10 years at 200 days/year and 1 cycle per day for a total 2000 cycles.

7. The programmable length of the extension cord 30 can be repeatable to within +/−1 inch.

8. The operating speed of the motorized spool 140 can be 1 +/−0.25 feet per second

9. The user will be able to “jog” the cord with the use of up/down buttons on the remote control 130 at any time up to the fully extended length of the extension cord 30.

10. The extension cord 20 can be able to manually extend at any time up to the fully extended length, by pulling on the cord with a force of at least 5 lbf.

11. Retraction will stop if there is force of at least 5 lbf acting the extension cord 30 in the downward direction. This is to protect the motor 150 and prevent an item being pulled up with the extension cord 30.

12. The sound emitted by the unit 10 will produce sounds of less than 60 dBA as measured from a distance of 20 feet.

13. The remote control 130 can be powered with batteries, and can last at least 6 months, used twice per day for 50 seconds at a time,

14. The remote control 130 can work from a distance of at least 25 ft.

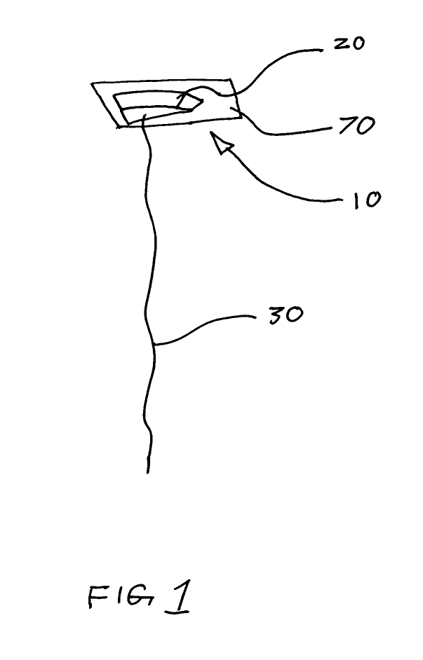

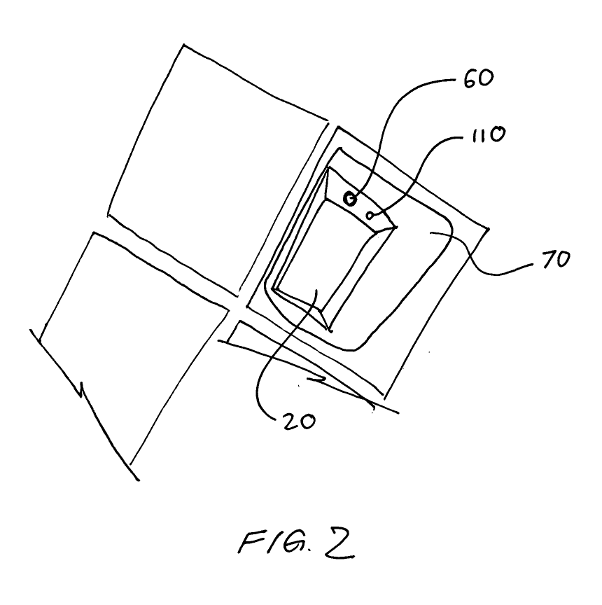

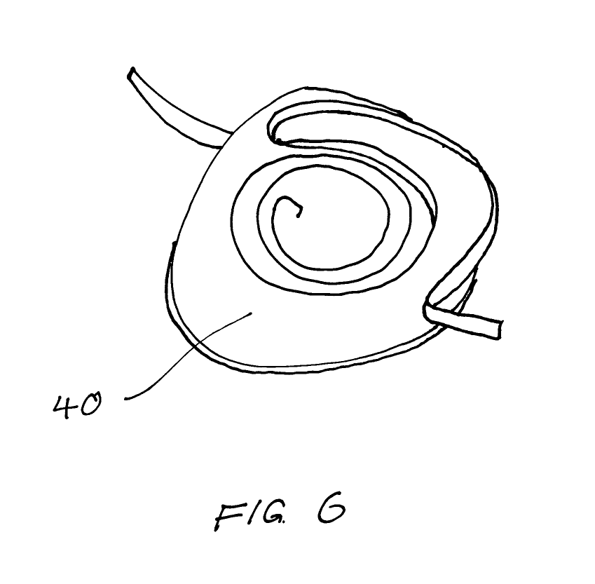

Referring to FIG. 1, the present invention 10, referred to herein as a mounted power cord 10 may be a modified HVAC diffuser 70 having a cord housing 20 that may have a displacement means 40 (illustrated in FIG. 6) that is operably connected to a power cord 30 so that the power cord 30 can be placed in a retracted position 80, as seen in FIG. 2 or a non-retracted position 90 as seen in FIG. 1.

FIG. 2 illustrates the power cord 30 having a cord plug portion 60, to allow devices to plug into the power cord 30. FIG. 2 also illustrates a circuit breaker reset button 110. FIG. 2 also illustrates an embodiment of the cord housing 20 secured to a diffuser.

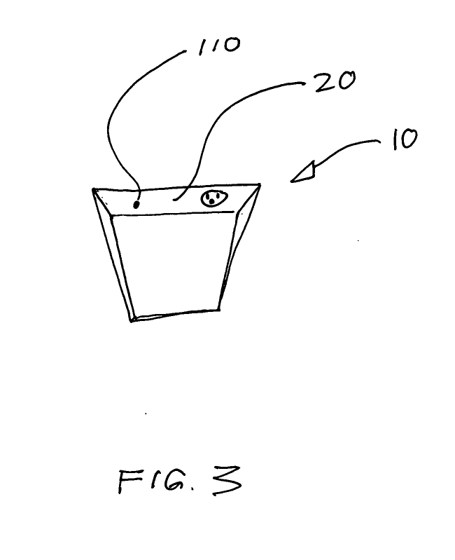

FIG. 3 illustrates another possible embodiment of the present invention 10 whereby the present invention 10 may be secured to a concave portion of a ceiling, or a concave shaped diffuser 70. The circuit breaker reset button 110 is also shown here.

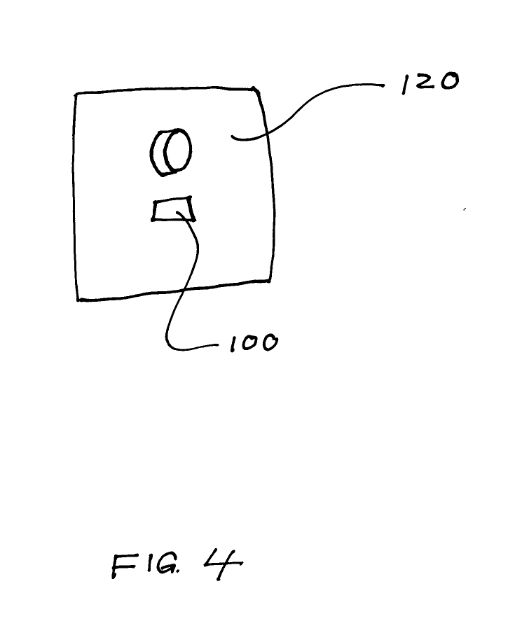

FIG. 4 illustrates the top side 120 of the cord housing 20. The top side 120 may have a power outlet 100 secured thereto. The power cord 30 may be operably connected to a power source 50 so that an electrical device, such as a projector or computer can be plugged into the cord plug portion 60 for electric power.

In one embodiment, the power source 50 may be a power outlet 100. In another embodiment, the power source 50 may be an input cable 170. The top side 120 may not be visible below when the diffuser 70 or cord housing 20 is installed in the ceiling.

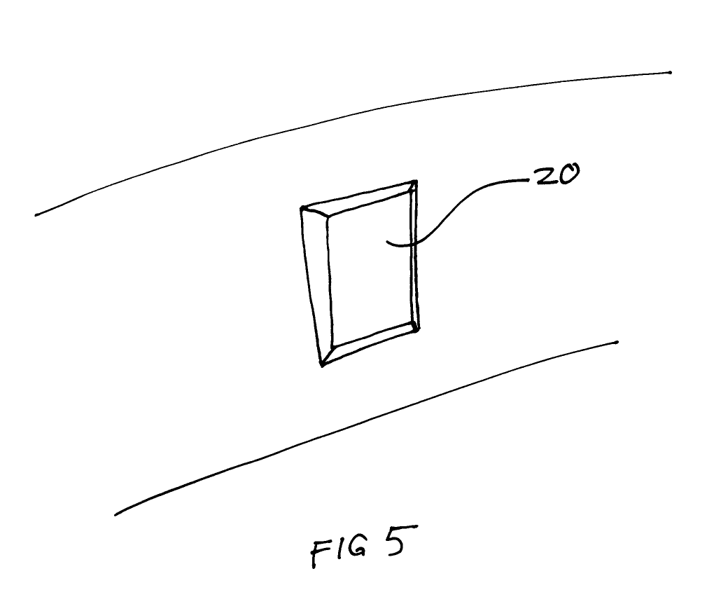

FIG. 5 illustrates an embodiment with the cord housing 20 secured to a wall.

FIG. 6 illustrates an embodiment of the retracting means 40 of the present invention 10.

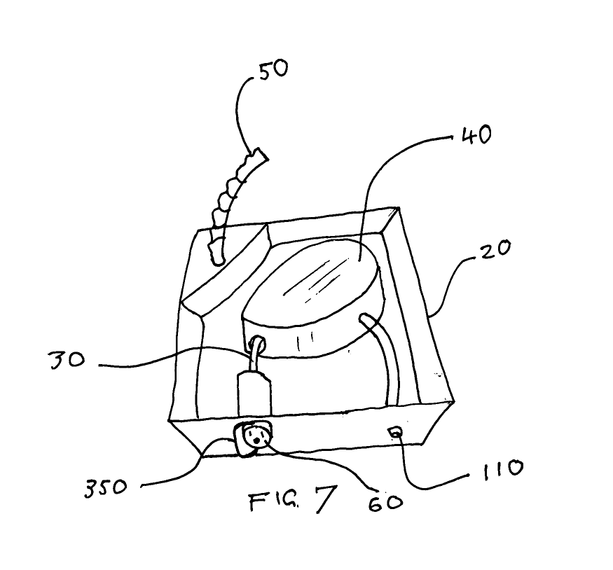

FIG. 7 illustrates an embodiment of the internal configuration of the present invention 10. A power cord 50 may be operably connected to an external power source to provide power to the power cord 30. A retracting means 40 may be secured in the housing so the power cord 30 can displace between a retracted position 80 and a non-retracted position 90. The retracting means 40 may provide for manual displacement, or motorized displacement.

In a further embodiment of the present invention 10, the power cord 30 may move from a retracted position 80 to a non-retracted position via a motorized retracting means 40. The displacement means 40 may have the capability of spooling the power cord 30 out or in, via either handheld remote 130, or possibly Bluetooth smartphone application 200

In another embodiment, the present invention 10 may have the ability to define the distance the power cord 30 spools out to.

In another embodiment, the present invention 10 may have the ability to remotely individually or multi-select several of the present inventions 10 in a room to simultaneously or individually retract or spool out the power cords 30.

One embodiment of the present invention 10 contains an enclosed, retractable power cord 30. The invention 10 provides an alternative to floor-based outlets providing a less hazardous environment. Because the present invention 10 houses a power cord 30 external to ceilings or wall planes it is also a safe alternative to extension cords that pass through walls, floors or ceilings.

Unlike most enclosed, retractable extension cord apparatus, the present invention 10 is ceiling assessable being that it may be connected to an HVAC diffuser 70 that is connected to a ceiling. This solution may cost less than one tenth that of a typical floor outlet and existing buildings could easily be retrofitted with it.

The present invention 10 also includes mounting the enclosed extension cord 30 on an ordinary wall, as in FIG. 5, near an outlet, and simply plugging it into an existing outlet. Both concepts result in a convenient extension cord that essentially disappears when not needed, yet is always available when needed. The present invention 10 device is ideally suited for industrial use, office use, and housekeeping.

Another embodiment of the present invention 10 is its capability to be attached to any type of ceiling, including but not limited to a drop ceilings, a concave shaped portion of a ceiling, plaster, industrial, or other ceiling. In this embodiment, the present invention 10 may be a remote control 130, motorized unit or a manual unit, but it would not be associated w/the HVAC diffuser 70 or the concave element. Here, the present invention 10 cord housing 20 would be affixed to any type of ceiling.

In one embodiment, the load of the system and the force from the user pulling on the cord may be supported using a rectangular tubes 210 made of aluminum. Minimal deflection was necessary to maintain that the shaft rotates well. A rectangular tube system was chosen due to its high moment of inertia. The frame may be directly connected to brackets and then to steel slack lines that are attached to the true ceiling. This provides an anchoring point for the mounted power cord 10, also referred to as the present invention 10.

In one embodiment, the design utilizes a tube-frame design. Aluminum tubes ⅛″ thick and 1″×2 n rectangular cross-sections support the weight of all the mechanical components in the design. This design was chosen over other options because due to the increase strength and reduced weight. Also, the rectangular tubes are good mounting points for the motor frame, clutch spring frame air flow tubes. Sheet metal screws hold the frame elements together.

The vertical gear motor that was selected is due to its relatively short height and high torque values. The motor that was selected was from Anaheim Automation and was model number BDPG-36-57-24V-4200-R27. The motor was further geared down at a 3:1 ratio to the clutch/pulley component.

To connect the output of the motor with the bottom-half of the clutch, a belt-drive system was implemented. A 1.5 inch outer diameter pulley was attached to the motor using a set screw and the clutch/pulley component has an outer diameter of 4.5 inches. This resulted in a further motor speed reduction of 3:1. A spring tension system was developed to allow tensioning of the belt as stretch results from use. Two springs were used to allow for this tensioning. Each spring had a force of 9.4 lbs with results in a total tensioning of 18.8 lbs. This tension was also to insure that the belt would not slip in normal operation.

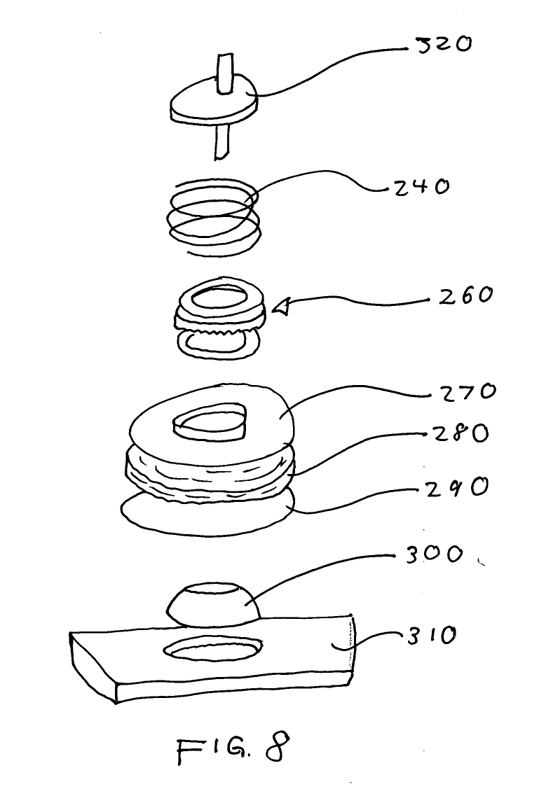

FIG. 8 illustrates one embodiment of the clutch 230 of the present invention 10. The clutch 230 will provide an operable link from the motor 150 to the spool 140, allowing for rotation.

The motor 150 is back drivable due to the way the motor 150 is geared. When a person pulls down on the extension cord 30 with minimal force a v-belt (not illustrated) will rotate and back drive the motor 150. If a person jerks the extension cord 30 the clutch 230 slips and will only back drive the motor minimally. The torque to slip the clutch was found to be 2.4 Nm. A spring 240 may provide the necessary contact force and also to allow for wear in clutch discs 250, which may include a thrust bearing 250, a top clutch plate 270, clutch material 280, and a bottom clutch plate 290.

In one embodiment, a spool hub 320 may be fixedly connected to the spool 140. Adjacent to the spool hub 320 may be the spring 240 downwardly therefrom. Downwardly from the spring 240 may be a thrust bearing 260. A top clutch plate 270 may be adjacent and downwardly from the thrust bearing 260. A bottom clutch plate 290 may be disposed downwardly from the top clutch plate 270, with clutch material 280 disposed between the top clutch plate 270 and the bottom clutch plate 280. Downwardly from the bottom clutch plate 290 may be a bearing 300 that may be disposed within a support bracket 310 to enable the spool hub 320 to rotate and the clutch 230 to operate properly.

The spring 240 may have a length of about 0.90 inches, and it may be compressed to a height of about 0.71 inches. This provided a force of 41.51 bs on the clutch surface. At this amount of force on the clutch, slipping occurs and does not allow the picking up of objects attached to the cord.

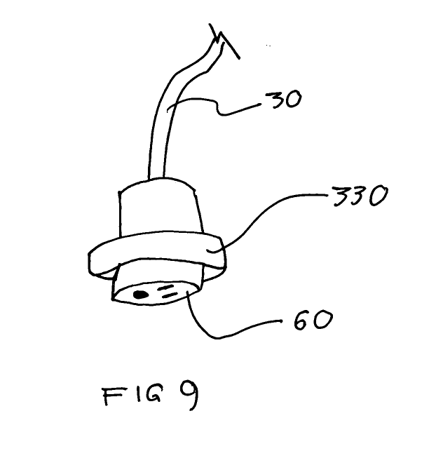

As seen in FIG. 9, a weight 330 of about 0.3 lbs shaped as a disc may be attached adjacent to the cord plug portion 60 to help pull the cord 30 out of the cord housing 20 system when the cord 30 is fully retracted. Two horizontal rollers (not illustrated) may be utilized that were allowed to move laterally to accommodate the spool diameter changing as the cord is extended or retracted.

DC-DC Switching Voltage Regulator 340 may be operably connected to the motor 150. One suitable Regulator 340 may be a 24 VDC to 12 VDC switching voltage regulator is the Alpha & Omega Semiconductor AOZ1280CI adjustable buck regulator. It may be able to supply up to 1.2 A of current and has an output voltage programmable by two feedback resistors.

In operation, in one embodiment, the diffuser and enclosure channels the air entering the top of the system and disperses the air around and out to the room below. The diffuser and enclosure carry minimal loads which include the air tube entering the system and the conduit box where the power cable enters. Therefore 16 gage (0.050″) aluminum was selected for the structure. The airflow enters the top of the enclosure and is directed through two rectangular tubes. The bottom of the system may be covered by 18 gage (0.040″) aluminum.

Although particular preferred embodiments of the invention have been discussed in detail for illustrative purposes, it will be recognized that variations or modifications of the disclosed apparatus, including the rearrangement of parts, lie within the scope of the present invention.

I claim:

1. A mounted power cord (10), comprising:
a displacement means (40) disposed on a ceiling;
a power cord (30) retractably connected to said displacement means (40); and
a power source (50) operably connected to said power cord (30).

2. The apparatus of claim 1, further comprising:
a pull ring (350) disposed on the cord plug portion (60) of the power cord (30).

3. The apparatus of claim 2, further comprising:
a spool (140) upon which the power cord (30) can be wound and positioned in at least one of either a retracted position (80) or a non-retracted position (90).

4. The apparatus of claim 1, wherein said displacement means 40 is disposed in at least one either (1) adjacent to a ceiling, (2) adjacent to a HVAC diffuser, (3) inside the HVAC diffuser, (4) inside a ceiling, or (5) above the ceiling.

5. The apparatus of claim 1, further comprising:
a motor (150) operably connected to said displacement means (40) so that the. power cord (30) can be positioned in at least one of either a retracted position (80) or a non-retracted position (90).

6. The apparatus of claim 5, further comprising:
a remote control (130) operably connected to said motor (150) that can control the motor (150) to displace the power cord (30).

7. The apparatus of claim 1, further comprising a weight (330) disposed adjacent to a cord plug portion (60) to help pull the cord (30) out of the cord housing (20) system when the cord (30) is in the retracted position (80).

8. The apparatus of claim 6, wherein said remote control (130) can control the motor (150) so as to position the cord plug portion (60) at a remembered position, a retracted position (80), or a non-retracted position (90).
